(19) United States
(12) Patent Application Publication
(10) Pub. No.: US 2023/0224028 A1
(43) Pub. Date: Jul. 13, 2023

(54) POSITIONING, NAVIGATION, AND TIMING (PNT) SATELLITE BEAM AND DATA SCHEDULING

(71) Applicant: Satelles, Inc., Reston, VA (US)

(72) Inventors: DAVID G. LAWRENCE, Santa Clara, CA (US); GREGORY GUTT, Herndon, VA (US); RACHEL SCHMALZRIED, San Jose, CA (US)

(21) Appl. No.: 17/575,490

(22) Filed: Jan. 13, 2022

(51) Int. Cl. H04B 7/185; H04W 28/24; H04B 7/19

(52) U.S. Cl. CPC H04B 7/18582; H04B 7/19; H04B 7/18586; H04W 28/24

(57) ABSTRACT

Aspects of the disclosure relate to positioning, navigation, and timing (PNT) satellite beam and data scheduling. In one or more embodiments, a method for determining a location and/or time offset of at least one receiver involves transmitting, by at least one satellite, at least one beam, which is a sweeping beam. In one or more embodiments, each of the beams comprises at least one signal used for positioning, navigation, or timing. The method further comprises varying, by at least one satellite, aspects of at least one signal based on optimization parameters. In at least one embodiment, the optimization parameters comprise a location of a beam footprint of at least one beam. In one or more embodiments, at least one receiver receives at least one signal. In at least one embodiment, the location and/or the time offset of at least one receiver is determined by using at least one signal.

### FIELD

The present disclosure relates generally to satellite scheduling. For example, aspects of the present disclosure relate to positioning, navigation, and timing (PNT) satellite beam and data scheduling.

### BACKGROUND

PNT satellites, which are often simply referred to as navigation satellites, are utilized for positioning, navigation, and/or timing. Currently, PNT satellites typically transmit the same information (e.g., the same data signal) within a single wide antenna beam (e.g., a global antenna beam) to all receivers located within the beam that can track the signal. This type of data transmission is often referred to as point to multi-point data transmission. Consequently, some receivers within the beam may receive information that they already have or do not currently need, before they receive information that they need, but do not yet already have.

Signals transmitted from the PNT satellites are used for the positioning, navigation, and/or timing of the receiver. Positioning refers to accurately determining the location (e.g., either two-dimensionally or three-dimensionally) with reference to a standard geodetic system; navigation refers to determining the current and desired position (e.g., relative or absolute) and applying corrections to the course, orientation, and speed to attain the desired position; and timing refers to acquiring and maintaining an accurate and precise time from a time standard (e.g., Coordinated Universal Time (UTC)).

Many PNT satellite systems have this design (e.g., to transmit a generic data signal within a single wide beam) and, thus, are faced with this challenge. As one example, Global Positioning System (GPS) satellites within the GPS satellite constellation, which is a Global Navigation Satellite System (GNSS), currently have this problem. GPS satellites transmit the same information to all of the receivers located within their global beam footprint. The data within the signal of the global beam is rotated through various subframes on a fixed schedule, independent of the transmitting satellite’s location relative to each receiver.

However, many PNT satellite systems have employed a combination of features, such as encrypted signals, authorized receivers, and decryption to control data accessibility. For example, the GPS satellites utilize for their data transmission a Civilian Access (C/A) Code and Precise (P) Code, which are transmitted on different chip rates and across different frequencies. The C/A Code is transmitted at a 1.023 megahertz (MHz) chip rate, while the P Code is transmitted at a 10.23 MHz chip rate. The C/A Code is transmitted on a single frequency (the L1 frequency), and the P Code is transmitted on two frequencies (the L1 and L2 frequencies). The GPS satellites historically have also employed at times intentional corruption of data (e.g., with selective availability) on the L1 frequency to deny full system accuracy to unauthorized users when enabled. Although these PNT satellite systems have employed these features to control data accessibility, these PNT satellite systems do not have the ability to provide customized signals to the receivers.

In light of the foregoing, there is a need for an improved design for a PNT satellite system that transmits specific customized signals to specific receivers.

### SUMMARY

Disclosed are systems, apparatuses, methods, and computer-readable media for PNT satellite beam and data scheduling. In one or more embodiments, a method for determining a location and/or time offset of at least one receiver involves transmitting, by at least one satellite, at least one beam, which is a sweeping beam. In one or more embodiments, each of the beams includes at least one signal used for positioning, navigation, and/or timing. The method further involves varying, by at least one satellite, aspects of at least one signal based on optimization parameters. In at least one embodiment, the optimization parameters include a location of a beam footprint of at least one beam. In one or more embodiments, at least one receiver receives at least one signal. In at least one embodiment, the location and/or the time offset of at least one receiver is determined by using at least one signal.

In one or more embodiments, the method further involves generating, by an optimizer using the optimization parameters, specifications for the aspects.

In at least one embodiment, the optimization parameters further include provider inputs and internal inputs. In one or more embodiments, the method further involves generating, by a simulator using the provider inputs, simulated receiver data. In one or more embodiments, further, the method involves generating, by an optimizer using the simulated receiver data, the internal inputs, and the location of the beam footprint of at least one beam, specifications of the aspects.

In one or more embodiments, the simulated receiver data is associated with at least one simulated service monitoring receiver. In some embodiments, the provider inputs include at least one user subscription specification, at least one service specification, at least one region of interest, at least one use case, at least one user receiver performance requirement, at least one receiver environment, and/or at least one broadcast requirement.

In at least one embodiment, each of the receiver environments includes environment attenuation and/or receiver mobility associated with at least one receiver. In one or more embodiments, each of the user subscription specifications includes a feature-based level of service (LoS), a LoS, and/or a quality of service (QoS) associated with at least one receiver. In some embodiments, the feature-based LoS includes at least one feature enabled. In one or more embodiments, each of the service specifications includes at least one input from a service level agreement (SLA) associated with at least one receiver. In one or more embodiments, each of the user receiver performance requirements is related to hardware associated with at least one receiver.

In one or more embodiments, each of the broadcast requirements is based on at least one user application associated with at least one receiver. In at least one embodiment, each of the user applications is based on a radio frequency (RF) environment and/or receiver mobility associated with at least one receiver. In some embodiments, each of the use cases is based on an RF environment, at least one region, and/or receiver mobility associated with at least one receiver. In one or more embodiments, each of the use cases is related to whether at least one receiver is a static receiver, a pseudo-static receiver, a low dynamic receiver, a highly dynamic receiver, a mobile receiver, an indoor receiver, an outdoor receiver, a land-based receiver, a high-altitude receiver, an air-based receiver, a marine-based receiver, an ocean-based receiver, a connected receiver, an unconnected receiver, and/or a combination of these. In some embodiments, the use case is related to the industry in which it is used, such as if the receiver is supporting at least one of the following industries: autonomous operation, automotive, aviation, communications, computer security, financial, delivery, industrial, marine, micromobility, mining, rail, robotics, unmanned systems, precision timing, or telecommunications. In some embodiments, each of the broadcast requirements is dependent upon at least one use case associated with at least one receiver.

In at least one embodiment, the internal inputs include costs, business constraints, input parameters, receiver performance associated with at least one receiver, collective user receiver performance, service thresholds, system performance, system constraints, output parameters, available resources, at least one satellite mission, and/or at least one satellite orbit.

In one or more embodiments, the optimization parameters further include a LoS associated with at least one receiver, a QoS associated with at least one receiver, at least one region of service associated with at least one receiver, a broadcast type associated with at least one receiver, costs, receiver performance associated with at least one receiver, business constraints, input parameters, collective user receiver performance, service thresholds, system performance, system constraints, output parameters, service monitoring receiver data, and/or available resources.

In at least one embodiment, the aspects of at least one signal include beam scheduling, data content, signal power, data coding gain, data rate, frequency, coding scheme, error correction, and/or modulation.

In one or more embodiments, when at least one receiver is located within at least two of the beams, which are overlapping, the beam scheduling involves scheduling each of two beams to alternately broadcast to at least one receiver.

In at least one embodiment, the signal power is varied based on specified power levels of at least one broadcast requirement. In one or more embodiments, the signal power is varied based on predicted signal attenuation due to indoor transmission, any obstructed views, receiver antenna gain, weather, interference, and/or jamming.

In one or more embodiments, the data content includes self-satellite information associated with at least one satellite, validation information associated with at least one satellite, authentication information associated with at least one satellite, authentication information associated with at least one receiver, and/or other-satellite information. In some embodiments, the self-satellite information includes an identifier, almanac, ephemerides, health data, and/or timing information corresponding to at least one satellite associated with the self-satellite information.

In at least one embodiment, the authentication information includes authentication data used to authenticate at least one receiver associated with the authentication information, when at least one receiver is determined to be located within an expected location corresponding to at least one receiver, by comparing the authentication data to a known valid data set, and authenticating at least one receiver when a difference between the authentication data and the known valid data is below a predetermined authentication threshold. In one or more embodiments, the validation information is used to validate authenticity of a source, which is at least one satellite, of each of the signals. In some embodiments, the validation information includes at least one digital signature corresponding to least one satellite.

In one or embodiments, when there is more than one beam transmitted, the aspects of at least one signal of at least some of the beams are varied similarly or differently.

In at least one embodiment, at least one satellite is a low earth orbit (LEO) satellite, a medium earth orbit (MEO) satellite, or a geosynchronous earth orbit (GEO) satellite. In some embodiments, the GEO satellite is a geostationary satellite.

In one or more embodiments, when there is more than one satellite, the satellites are LEO satellites, MEO satellites, GEO satellites, or a combination thereof. In some embodiments, at least one satellite is within a satellite constellation. In some embodiments, when there is more than one satellite, the satellites are within at least one satellite constellation. In at least one embodiment, a satellite constellation may include a combination of orbital constellation configurations.

In at least one embodiment, when there are at least two receivers with different service requirements that are all located at a location that is illuminated by a beam footprint of at least one beam from at least two satellites, at least one signal within each of the beams from the satellites includes multiplexed data for all of the receivers. In some embodiments, the multiplexed data is multiplexed by utilizing a time multiplexing scheme and/or a frequency multiplexing scheme.

In one or more embodiments, the sweeping of each of the beams is achieved by at least one satellite associated with each of the beams moving across a surface of Earth and/or at least one antenna of at least one satellite associated with each of the beams scanning at least one beam. In at least one embodiment, each of the beams is scanned by gimballing at least one antenna and/or changing a phase of at least one beam. In some embodiments, at least one antenna includes a reflector antenna, a patch antenna, a helix antenna, a cup-dipole antenna, a dipole antenna, a monopole antenna, a direct radiating array antenna, and/or a phased array antenna. In at least one embodiment, each beam footprint of at least one beam is smaller in size than each satellite footprint of at least one satellite on Earth.

In one or more embodiments, when there is more than one beam transmitted, one of the beams is a leading beam that includes at least a portion of a first type of data, and another one of the beams is a trailing beam that includes at least a portion of a second type of data. In some embodiments, the leading beam and the trailing beam may both transmit common data (e.g., which may be the first type of data and/or the second types of data), but a percentage of the data type within the broadcast is varied (e.g., the leading beam and the trailing beam will transmit at least a portion of data that is not common to both the leading beam and the trailing beam). In some embodiments, at least a portion of the aspects of at least one signal in the leading beam are varied differently than at least a portion of the aspects of at least one signal in the trailing beam.

In at least one embodiment, a system for determining a location and/or time offset of at least one receiver includes at least one satellite configured to transmit at least one beam, which is a sweeping beam. In one or more embodiments, each of the beams includes at least one signal used for positioning, navigation, and/or timing. In some embodiments, at least one satellite is further configured to vary aspects of at least one signal based on optimization parameters. In at least one embodiment, the optimization parameters include a location of a beam footprint of at least one beam. In one or more embodiments, at least one receiver receives at least one signal. In some embodiments, the location and/or the time offset of at least one receiver is determined by at least one PNT processor using at least one signal.

In one or more embodiments, at least one PNT processor, at least one simulator processor, and/or at least one optimizer processor is located in at least one receiver, in at least one server, on at least one of the at least one satellite, and/or a combination thereof.

In at least one embodiment, the system further includes at least one optimizer processor configured to generate, by running an optimizer using the optimization parameters, specifications for the aspects. In some embodiments, the optimizer performs a weighted parameter analysis and/or a cost function analysis. In one or more embodiments, the optimizer includes an intelligent broadcast scheduler configured to generate at least one broadcast schedule. In at least one embodiment, the optimizer includes a region controller configured to specify at least one region to illuminate with at least one beam.

In one or more embodiments, the optimization parameters further include provider inputs and internal inputs. In at least one embodiment, the system further includes at least one simulator processor configured to generate, by running a simulator using the provider inputs, simulated receiver data. In one or more embodiments, the system further includes at least one optimizer processor configured to generate, by running an optimizer using the simulated receiver data, the internal inputs, and the location of the beam footprint of at least one of the at least one beam, specifications of the aspects. In some embodiments, the simulator employs machine learning.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

FIG. 1A is a diagram of the disclosed PNT satellite beam and data scheduling system employing an exemplary disclosed PNT satellite, in accordance with at least one embodiment of the present disclosure.

FIG. 1B is a diagram of exemplary processors that may be employed by the disclosed PNT satellite of the disclosed PNT satellite beam and data scheduling system, in accordance with at least one embodiment of the present disclosure.

FIG. 1C is a diagram of the disclosed PNT satellite and data scheduling system leveraging a simulated receiver network, in accordance with at least one embodiment of the present disclosure.

FIG. 2 is a flowchart illustrating a disclosed method of operation of the disclosed PNT satellite beam and data scheduling system, in accordance with at least one embodiment of the present disclosure.

FIG. 3A is a flowchart illustrating a disclosed method for determining specifications for aspects of signals transmitted from PNT satellites of the disclosed PNT satellite beam and data scheduling system, in accordance with at least one embodiment of the present disclosure.

FIG. 3B is a flowchart illustrating a disclosed method, utilizing simulated receiver data, for determining specifications for aspects of signals transmitted from PNT satellites of the disclosed PNT satellite beam and data scheduling system, in accordance with at least one embodiment of the present disclosure.

FIG. 4 is a diagram showing exemplary orbital paths of multiple disclosed PNT satellites that may be employed for the disclosed PNT satellite beam and data scheduling system, in accordance with at least one embodiment of the present disclosure.

FIG. 5 is a diagram showing multiple different receivers located within antenna beams transmitted from a disclosed PNT satellite of the disclosed PNT satellite beam and data scheduling system, where one of the receivers is located within two of the beams, in accordance with at least one embodiment of the present disclosure.

FIG. 6 is a diagram showing multiple different receivers located within antenna beams transmitted from at least one disclosed PNT satellite of the disclosed PNT satellite beam and data scheduling system, where two of the receivers are located within two of the beams, in accordance with at least one embodiment of the present disclosure.

FIG. 7 is a diagram showing multiple different receivers located within an antenna beam transmitted from a disclosed PNT satellite of the disclosed PNT satellite beam and data scheduling system, in accordance with at least one embodiment of the present disclosure.

FIG. 8 is a diagram showing the disclosed PNT satellite beam and data scheduling system employing multiple disclosed PNT satellites from multiple exemplary satellite constellations, in accordance with at least one embodiment of the present disclosure.

FIG. 9 is a diagram showing two exemplary disclosed PNT satellites, each radiating a leading antenna beam and a trailing antenna beam, that may be employed for the disclosed PNT satellite beam and data scheduling system, in accordance with at least one embodiment of the present disclosure.

FIG. 10 is a diagram showing geometry for a disclosed PNT satellite of the disclosed PNT satellite beam and data scheduling system, in accordance with at least one embodiment of the present disclosure.

### DETAILED DESCRIPTION

The methods and apparatuses disclosed herein provide operative systems for PNT satellite beam and data scheduling. In one or more embodiments, the system of the present disclosure employs a plurality of PNT satellites, from one or more satellite constellations, each with one or more orbital constellation configurations (e.g., including orbital inclinations), that provide antenna beams containing customized signals (which are used for positioning, navigation, and/or timing) for specific receivers.

As previously mentioned above, PNT satellites transmit information (e.g., a data signal) to user receivers to assist in PNT related computations, such as to aid a receiver in the computation of its position, navigation, and/or timing. This computation may support a specific receiver, which may also be coupled (e.g., networked) to a system that this data supports.

The disclosed PNT satellites can vary the transmission of the signals for the specific receivers by varying aspects of the signals, which may include varying the data content of the signals and/or varying the characteristics of the transmission of the signals themselves. As such, the type of data (e.g., data content types) within a signal and/or the transmission of the signal from a satellite’s beam configuration (e.g., a single-beam or multi-beam architecture) to a specific user or set of users on the ground can be varied (e.g., a variation of the transmission power level and/or frequency of the signal), which can be based on a given satellite constellation’s mission, or even a mission for a subset of satellites within the satellite constellation.

For example, some specific applications and/or use cases may require the transmission of the signals to have more power and/or coding gain to overcome instances of attenuation (e.g., which may occur from transmissions going into indoor environments, underground, occluded and/or obstructed views), interference, and/or jamming scenarios. In addition, different power levels and/or message types with different coding gains can be used for the transmission of signals to support applications with different requirements. Further, some applications and/or use cases may require different data content (e.g., validation data and/or authentication data, and/or other data content based on at least one use case, subscription type, and/or feature-based LoS) within the signals to support different performance tradeoffs such as data quantization, time to fix, etc.

It should be noted that the disclosed methods described in the present disclosure may be employed by system architectures that are cooperative across beams from a set of two or more satellites within one or more satellite constellations. In one or more embodiments, satellites with multiple beams can send bursts and data as a function of broadcast coverage region. In one or more embodiments, satellites with multiple beams can send bursts and data as a function of receiver location by scheduling the beams and the data on those beams as an approximate function of the location of the user. It should be noted that herein when referring to a location of a receiver or geographical region of a receiver, it is understood to include an approximate location or a presumed location based on a service coverage region.

In one or more embodiments, a disclosed method involves optimizing a solution for varying the transmitted signals (e.g., optimizing specifications of the aspects of the signals to be varied) through the weighing of various input parameters and adjusting for factors such as cost, user performance, service thresholds, system performance, system constraints, bandwidth availability, best available data, and/or message scheduling arrangements for at least one receiver located within a specific region. In some cases, only one solution may be identified as feasible. While in other cases, there may exist more than one solution, and a preferred solution may be indicated, or the priority of a solution may be assessed based on the most influential factors.

Additional details regarding the disclosed PNT satellite beam and data scheduling system, as well as specific implementations, are described below.

The following description of the embodiments of the invention is not intended to limit the invention to these embodiments, but rather to enable any person skilled in the art to make and use this invention. As such, the detailed description set forth below in connection with the appended drawings is intended as a description of exemplary implementations and is not intended to represent the only implementations in which the invention may be practiced. The term “exemplary” used throughout the description means “serving as an example, instance, or illustration,” and should not necessarily be construed as preferred or advantageous over other exemplary implementations. The detailed description includes specific details for the purpose of providing a thorough understanding of the exemplary implementations. In some instances, some devices are shown in block diagram form. Drawing elements that are common among the following figures may be identified using the same reference numerals.

In the following description, numerous details are set forth in order to provide a more thorough description of the system. It will be apparent, however, to one skilled in the art, that the disclosed system may be practiced without these specific details. In the other instances, well known features have not been described in detail, so as not to unnecessarily obscure the system.

Embodiments of the present disclosure may be described herein in terms of functional and/or logical components and various processing steps. It should be appreciated that such components may be realized by any number of hardware, software, and/or firmware components configured to perform the specified functions. For example, an embodiment of the present disclosure may employ various integrated circuit components (e.g., memory elements, digital signal processing elements, logic elements, look-up tables, or the like), which may carry out a variety of functions under the control of one or more processors, microprocessors, or other control devices. In addition, those skilled in the art will appreciate that embodiments of the present disclosure may be practiced in conjunction with other components, and that the systems described herein are merely example embodiments of the present disclosure.

For the sake of brevity, conventional techniques and components related to PNT satellite systems, and other functional aspects of the overall system may not be described in detail herein. Furthermore, the connecting lines shown in the various figures contained herein are intended to represent example functional relationships and/or physical couplings between the various elements. It should be noted that many alternative or additional functional relationships or physical connections may be present in one or more embodiments of the present disclosure.

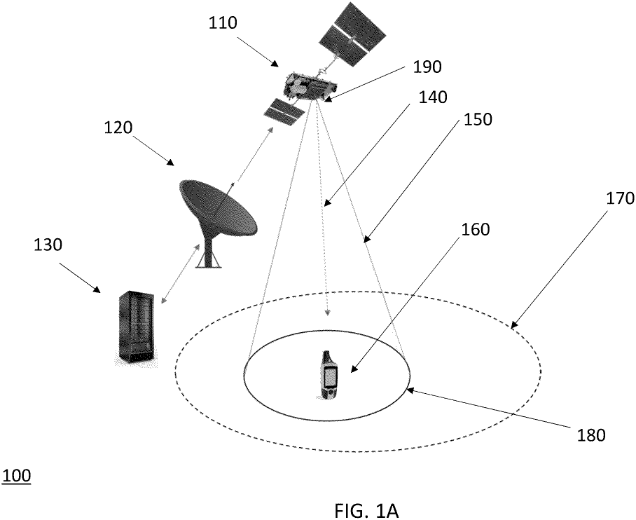

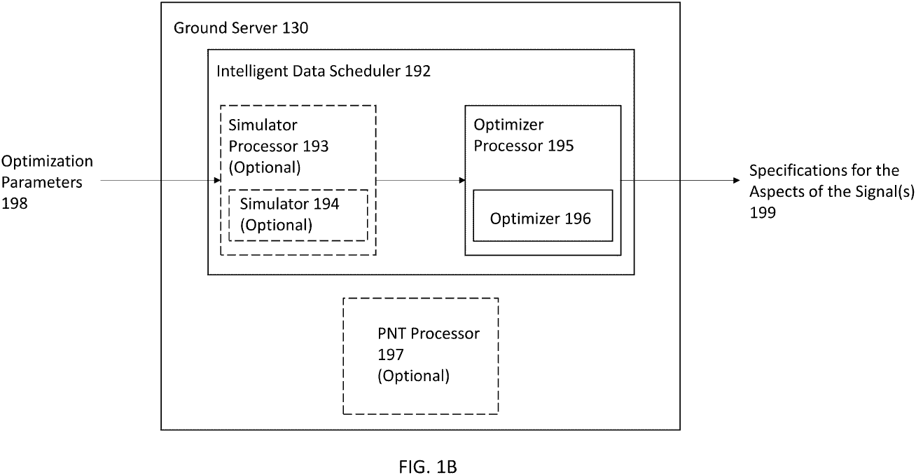

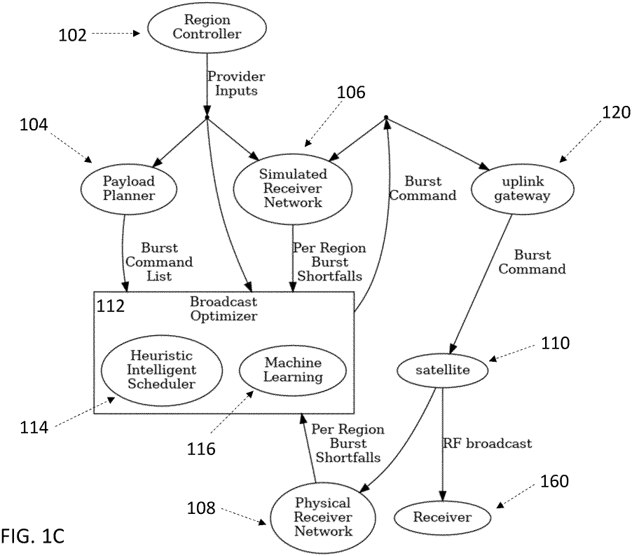

FIG. 1A is a diagram of the disclosed PNT satellite beam and data scheduling system 100 employing an exemplary disclosed PNT satellite 110, in accordance with at least one embodiment of the present disclosure. In this figure, the system is shown to comprise a PNT satellite 110, a ground server 130, a gateway antenna 120 (e.g., a feeder link), and a receiver 160, which is depicted in the form of a satellite phone.

The satellite phone may be an authorized receiver, such as a Satellite Time and Location (STL) authorized receiver, that may be known to the system’s ground infrastructure via a serial number. The receiver 160 (e.g., satellite phone) is enabled to receive satellite transmissions from the PNT satellites (e.g., PNT satellite 110) of the system 100.

The disclosed system 100 may include more than one PNT satellite 110, as is shown in FIG. 1A. In one or more embodiments, the disclosed system 100 may employ PNT satellites from one or more different satellite constellations, which may have one or more different orbits with one or more different orbital inclinations. The PNT satellites of the disclosed system 100 may be in various different orbits including, but not limited to, a Low Earth Orbit (LEO), a Medium Earth Orbit (MEO), a Geosynchronous Earth Orbit (GEO) (e.g., a Geostationary Earth Orbit), a Polar Orbit, and/or a Sun-synchronous Orbit at various different orbital inclinations. For example, satellites that may be employed by the disclosed system 100 include, but are not limited to LEO constellation satellites (e.g., Iridium, SpaceX, Starlink, and OneWeb, as well as small or nanosat constellations, such as LeoSat, TeleSat, Hongyan, and SpaceBEEs), GNSS satellites (e.g., GPS, Galileo, GLONASS, and BeiDou), and/or MEO constellation satellites (e.g. GPS and O3b). In one or more embodiments, satellites within multiple different orbit configurations and/or satellite constellations are employed by the disclosed system.

It should be noted that GNSS satellites are designed for global PNT, inclusive of constellations such as GPS, GLONASS, Galileo, and/or Beidou. In other cases, GNSS is a term more generally used to describe any satellite constellation that provides PNT services on a global or regional basis. Some examples of GNSS satellites include GPS, GLONASS, and Galileo satellites, which are all MEO satellites. While other examples of GNSS satellites including BeiDou, Compass, and others, such as the regional Quasi-Zenith Satellite System (QZSS) and Indian Regional Navigation Satellite System (IRNSS) that have at least some satellites in other orbits. The term GNSS may also be used in reference to Iridium as well as any other current or future systems or extensions of those systems and constellations that may be used for PNT applications whether or not they were designed originally for such.

It should also be noted that if the PNT satellites of the disclosed system 100 are located within a low orbit (e.g., LEO), the signals transmitted from the PNT satellites may be high-power signals that can be used to compliment or backup GPS, by being capable of penetrating into GPS-challenged environments where signals are obstructed or degraded, including indoors. PNT satellites with complex, overlapping beam patterns (e.g., such as Iridium satellites) may be employed by the disclosed system 100. Complex overlapping beam patterns combined with modem cryptographic techniques can allow the disclosed system 100 to provide accurate time and position information, while being highly secure.

In one or more embodiments, when a user initially activates the receiver 160 (e.g., also referred to as a user receiver), the user may select from a range of broadcast subscription service offerings (e.g., comprising user subscription specifications and/or service specifications). These service offerings may be based on contextual factors to help best support the user’s specific needs/use cases, and may include considerations, such as user location (e.g., worldwide, country, United States, continental United States (CONUS), and Outside Continental United States (OCONUS)), end use case/application (e.g., applications that may be relevant to a static receiver, such as to support timing applications or to a dynamic receiver that may need the service to support positioning or navigation), planned operating environment (e.g., a high attenuation environment, such as deep indoors, or a low attenuation environment, such as outside in clear sky view), as well as general level and QoS requirements (e.g., in support of a specific system up-time). The specific type of broadcast subscription (e.g., comprising user subscription specifications and/or service specifications) may be tracked associated with a unique serial number, which is associated with the receiver 160.

In some embodiments, some broadcast characteristics of a general service (e.g., which may be at least one broadcast subscription service offering) may be based on requests in a business-to-business (B2B) arrangement. An example of this may be where a company, such as the United Parcel Service (UPS), has enabled some of their supporting infrastructure (e.g., servers, automobiles, and/or drones) with receivers that can use the broadcast service. In this arrangement, the company may initiate broadcasts based on their specific needs through the service provider (e.g., a PNT service provider) to cover specific regions of interest. In another embodiment, the service provider may also directly provide broadcast service to consumers to support consumer needs. In yet another embodiment, a third-party reseller may sell or otherwise bundle the service offering from the service provider.

The service provider’s system may utilize an intelligent data scheduler (e.g., refer to intelligent data scheduler 192 of FIG. 1B) that employs an optimization function to assess the best available solutions (e.g., specifications for aspects of signals transmitted by a satellite(s), such as PNT satellite 110, within the system 100) for delivering the required data to the authorized receiver(s). This intelligent data scheduler may reside in the payload planning or payload generation software that is employed by a processor(s) within the ground infrastructure (e.g., ground server 130). However, in alternative embodiments, the intelligent data scheduler may reside in some or all of the satellites (e.g., PNT satellite 110) within the constellation in-orbit. If the satellite has crosslinking capabilities, such as an Iridium satellite, the intelligent data scheduler may be stored and run on a subset of the satellites (e.g., PNT satellite 110) within the system 100 that are capable of supporting the full set of satellites within the system 100.

In one or more embodiments, the solution (e.g., the specifications for aspects of the signals to be transmitted by the satellite 110) is generated (e.g., by the intelligent data scheduler, which includes an optimizer, such as optimizer 196 of FIG. 1B) located within the ground server 130. After the solution has been generated, the solution may be transmitted through the ground infrastructure gateway antenna 120 (e.g., feeder link) to the PNT satellite 110 for transmission to the region of interest. The PNT satellite 110 uses at least one RF antenna 190 to emit via an antenna beam 150 to the receiver 160, which may be located on the ground, underground, on the water, in the air, or in space.

In general, during operation of the disclosed system 100, the PNT satellite 110 transmits, via the antenna 190 on the PNT satellite 110, an antenna beam 150 comprising at least one signal 140 towards Earth. The signal 140 is used for positioning, navigation, or timing for the receiver 160. It should be noted that the PNT satellite 110 may comprise more than one antenna 190 and may radiate more than one antenna beam 150, as is shown in FIG. 1A. Various different types of antennas may be employed for the antenna 190 including, but not limited to, a reflector antenna, a patch antenna, a helix antenna, a cup-dipole antenna, a dipole antenna, a monopole antenna, a direct radiating antenna, and/or a phased array antenna.

The antenna beam 150 radiates on Earth and forms a beam footprint 180 on the ground and/or on the ocean. In one or more embodiments, the antenna beam 150 is a sweeping beam, which may be achieved by the antenna 190 scanning the beam 150 and/or by the PNT satellite 110 moving across the surface of the Earth. The antenna 190 may scan the beam by gimballing the antenna 190 itself while it is radiating the beam 150 and/or by changing the phases of an array of elements of a phased array antenna or otherwise electronically steering the beam 150, which causes the beam 150 to scan. The beam footprint 180 is smaller in size than a satellite footprint 170 of the PNT satellite 110.

Also during operation of the disclosed system 100, the PNT satellite 110 may vary aspects of the signal 140 (which are related to the transmission of the signal 140) based on optimization parameters (e.g., refer to optimization parameters 198 of FIG. 1B) for efficiently and effectively delivering the required data to the receiver 160. It should be noted that when the PNT satellite 110 transmits on more than one antenna beam (e.g., beam 150) as is shown in FIG. 1A, the aspects of the signals within each of the beams may be varied similarly or differently. The optimization parameters may include, but are not limited to, the location of the beam footprint 180 encompassing the receiver 160 or, alternatively, the broadcast region or a region encompassing the estimated or presumed location of the receiver. It should be noted that more than one receiver may be employed as is shown in FIG. 1A.

After the receiver 160 receives the signal 140 transmitted from the PNT satellite 110, at least one PNT processor (e.g., refer to PNT processor 197 of FIG. 1B) determines the location and/or a time offset for the receiver 160 by using the signal 140. The PNT processor(s) may utilize at least a portion of the data within the signal 140 and/or at least some of the characteristics of the transmission of the signal 140 (e.g., doppler frequency and/or ranging) to make the PNT determinations. It should be noted that the PNT processor(s) may be located within the receiver 160, on the PNT satellite 110, and/or within the ground server 130 (as is shown in FIG. 1B).

In one or more embodiments, the aspects of the signal 140 (which may be varied) include, but are not limited to, beam scheduling, data content (e.g., the specific types of data transmitted within the signals may be varied), signal power levels (e.g., which may depend upon whether the receiver is located on land, underground, or on a boat in the ocean, and/or depend upon whether the receiver is located indoors or outdoors), data coding gain, data rate, frequency (e.g., varied for deconfliction and/or identification), coding scheme, error correction (e.g., employing various different error correcting codes), and/or modulation (e.g., Code Division Multiple Access (CDMA) and/or frequency modulation).

The beam scheduling may be based on various different optimization parameters (e.g., refer to optimization parameters 198 of FIG. 1B). A discussion regarding the use of different optimization parameters to vary the beam scheduling follows. In one or more embodiments, beam scheduling may involve orbital parameters and clocks (timing) related to the transmitting satellite (e.g., PNT satellite 110). In addition, beam scheduling may be based on regional data with attenuation statistics (e.g., a percentage of receivers that are indoors for particular regions). For example, if eighty (80) percent (%) of customers in Europe are indoors and only thirty (30) % of customers in Australia are indoors, broadcasts of beams in these regions can be optimized differently. Also, beam scheduling may be based on regional data about customer applications. For example, static users with a known location and high-quality clocks may have different service requirements than outdoor dynamic users with less clock stability and, as such, broadcasts of beams for these applications can be optimized differently.

Additionally, beam scheduling may be based on expected navigation performance. For example, as part of the beam scheduling process, the navigation performance expected by receivers in various locations (e.g., within a grid over coverage regions) may be simulated (e.g., by a simulator, such as simulator 194 of FIG. 1B). The simulation may include a Monte Carlo analysis at each point to model some missed bursts in marginal attenuation environments. The beam scheduling may be varied to dynamically schedule what is sent in a beam, or by a satellite with a single beam, to minimize some cost function related to navigation performance, such as a Kalman Filter position error covariance. Artificial intelligence (AI) and/or machine learning may also be used in the dynamic scheduling process.

In addition, beam scheduling may use negative scheduling to exclude regions from getting specific content. For example, beam scheduling can be used to test broadcasts of new features that are not tracked (or will have very low signal-to-noise ratio (SNR)) in customer regions.

Beam scheduling may involve, when at least two antenna beams (e.g., beam 150) are encompassing a receiver (e.g., receiver 160), scheduling the antenna beams to alternately broadcast to the receiver to conserve available resources. For example, when two satellites have overlapping footprints over a receiver, broadcasts can be adjusted to dynamically deconflict the beams and/or to save satellite transmission power. For example, static applications may require lower burst rates than dynamic applications. In regions with a high percentage of static users, broadcasts from different satellites with overlapping coverage can be alternated to save power.

In another example of beam scheduling, when primary beam scheduling algorithms cause significant overlap between beams from two satellites at the same time with overlapping bandwidth (similar doppler), the broadcast could be modified to alternate between the beams and/or to adjust the timing and/or broadcast frequency of the beams.

The data content (e.g., types of data) that the signals (e.g., signal 140) transmitted from the PNT satellites (e.g., PNT satellite 110) to the receivers (e.g., receiver 160) may include, but are not limited to, are self-satellite information, validation information, authentication information, other-satellite information, other data content based on use case, subscription type, and/or feature-based LoS. Self-satellite information is information relating to the specific satellite (e.g., PNT satellite 110) that is transmitting the signal(s) (e.g., signal 140). The types of information that self-satellite information may include, but are not limited to, are satellite identification information (e.g., which may be related to the satellite and, optionally, other satellites in the constellation), a satellite almanac (e.g., which may include information regarding the state of health and/or coarse data of the orbit of the satellite and, optionally, of the entire satellite constellation), ephemerides (e.g., which may contain information, such as week number, satellite accuracy, satellite health, age of data, satellite clock correction coefficients, and orbital parameters), health data, clock information (e.g., which may include a time offset (e.g., from a time standard, such as UTC) and/or other various corrections or significant biases that may support the receiver and/or a networked system.

Validation information is information that is used to validate the authenticity of the source (e.g., PNT satellite 110) of the transmission of the signal (e.g., signal 140). The validation information may include, but is not limited to, at least one digital signature corresponding to the source (e.g., the PNT satellite) of the signal. Authentication information comprises authentication data that is used to authenticate a receiver (e.g., receiver 160) associated with the authentication information. In one or more embodiments, when the receiver is determined to be located within an expected location for that particular receiver, the authentication data for that receiver is compared to a known valid data set. The receiver is authenticated (e.g., deemed authentic), when the difference between the authentication data and the valid data set is less than a predetermined authentication threshold (e.g., a predetermined threshold value).

The other-satellite information comprises information for other satellites within the same satellite constellation and/or a different satellite constellation. The types of information that the other-satellite information for other satellites within the same satellite constellation may include, but are not limited to, orbit and/or clock information for a trailing satellite (e.g., another satellite located behind the satellite within the same orbital path) and/or for other plane satellites (e.g., other satellites located within an adjacent plane of the satellite). The other-satellite information for other satellites within a different satellite constellation may include, but is not limited to, GPS ephemeris validation information.

The signal power of the transmitted signals (e.g., signal 140) may be varied based on specified power levels of at least one broadcast requirement and/or based on predicted signal attenuation due to indoor transmission, any obstructed views, receiver antenna gain, weather, interference, and/or jamming.

The data coding gain may include different coding gains, such as a null coding gain (e.g., where no data, except an acquisition pattern, is transmitted), a low coding gain (e.g., having one (1) bit of information per modulated bit, with optionally a short cyclic redundancy check (CRC)), a medium coding gain (e.g., which is a coding gain between the low coding gain and a high coding gain), and the high coding gain (e.g., having many modulated bits per information bit, such as ten (10) to 1 or more).

The data rate may include different rates, such as a slow data rate, a medium data rate, and a fast data rate. For example, the slow data rate may be used for transmission of a timing offset (e.g. a UTC offset) and/or International Earth Rotation and Reference Systems Service (IERS) data, the medium data rate may be used for the transmission of ionosphere data and/or orbital parameters (e.g., some parameters change faster than others and, as such, can be updated at a faster rate), and the fast data rate may be used for the transmission of satellite clock information (e.g., the satellite clock bias often changes faster relative to the orbital parameters).

FIG. 1B is a diagram of exemplary processors that may be employed by the disclosed ground server 130 of the disclosed PNT satellite beam and data scheduling system 100 (refer to FIG. 1A), in accordance with at least one embodiment of the present disclosure. The system 100 may utilize an intelligent data scheduler 192 that employs an optimization function to assess the best available solutions (e.g., specifications of aspects 199 for the transmission of the signal 140) for delivering the required data to the receiver 160. In one or more embodiments, the intelligent data scheduler 192 may comprise an optimizer 196 and, optionally, a simulator 194. At least one optimizer processor 195 may run the optimizer 196, and at least one optional simulator processor 193 may run the simulator 194. At least one optimizer processor 195 and/or at least one simulator processor 193 of the intelligent data scheduler 192 may reside on the ground server 130 (as is shown in FIG. 1B), within the PNT satellite 110, and/or within the receiver 160.

Generally, the intelligent data scheduler 192 comprises an optimizer 196 without the use of a simulator 194. For these embodiments, during operation, at least one optimizer processor 195 runs the optimizer 196 to generate specifications for aspects of the signal 199 (e.g., for the transmission of signal 140), by using optimization parameters 198. In one or more embodiments, the optimization parameters 198 may include, but are not limited to, the location of the beam footprint 180 encompassing the receiver 160, at least one LoS associated with the receiver 160, at least one QoS associated with the receiver 160, at least one region of service associated with the receiver 160, a broadcast type associated with the receiver 160, costs, receiver performance of the receiver 160, input parameters, collective user receiver performance, service thresholds, system performance, business constraints, system constraints, output parameters, service monitoring receiver data, and/or available resources.

In one or more embodiments, the region of service may comprise at least one specified bounded region and/or at least one geographical region for service for the receiver 160. The broadcast type may be dependent upon, but not limited to, whether the receiver 160 is located on land, underground, or on the ocean, whether the receiver 160 is located indoors or outdoors, and/or whether the receiver 160 is mobile or stationary. The costs may include, but are not limited to, costs associated with satellite broadcasts, bandwidth, and/or transmission rate. The receiver performance of the receiver 160 may include, but is not limited to, a time to fix, accuracy, integrity, failure tolerances, and/or PNT accuracy. The input parameters may include, but are not limited to, the location of the receiver 160 (e.g., the location of the receiver may be known or assumed to be in a specific broadcast region or, alternatively, could be a precise location), user subscription data for one more existing customers, a user application (e.g., based on the RF environment and/or the mobility of the receiver 160) and/or the receiver environment (e.g., associated with environment attenuation and/or receiver mobility) as well as data and transmission requirements based on these inputs.

The collective user receiver performance may be optimized over potentially multiple locations, user application, user cases, and/or transmission environments. The service thresholds may include thresholds such as those set by the entity whose satellite is transmitting the data, or thresholds set by the entity that is providing the service to the receiver. In some embodiments, the service thresholds can include up-time requirements from a service level agreement (SLA) as well as other QoS and/or LoS requirements. The system performance may be related to all satellites (e.g., PNT satellite 110) within the system 100 (even satellites excluded from standard operations), and may include satellite or satellite constellation coverage and/or satellite power usage (e.g., by utilizing different power levels and available message types with different coding gains). The business and/or system constraints may include satellite, broadcast, and/or bandwidth availability constraints as well as include constraints related to the number of beams on a specific satellite and/or satellite power thresholds (e.g., such as per orbit power consumption), or can also include considerations around a multi-constellation configuration (different satellite constellation missions, orbital configurations, and so forth). The output parameters may include data and message scheduling methodologies (e.g., various beam scheduling of beams of a satellite) that result from contextual-based inputs.

In other embodiments, a simulator 194 may be employed by the intelligent data scheduler 192 to generate simulated receiver performance data of at least one simulated receiver (e.g., a simulated service monitoring receiver) located at the same location (or a nearby location, such as located within the same beam footprint 180 or geographical region) as the receiver 160 and having the same performance requirements, environmental effects, and capabilities as the receiver 160. For these embodiments, the intelligent data scheduler 192 may comprise both an optimizer 196 and a simulator 194.

During operation of these embodiments, at least one simulator processor 193 runs the simulator 194 to generate simulator receiver data by using at least provider inputs of the optimization parameters 198. After the simulated receiver data has been generated, at least one optimizer processor 195 runs the optimizer 196 to generate the specifications of the aspects of the signal 199 by using the simulated receiver data, internal inputs of the optimization parameters 198, and the location of the beam footprint 180 encompassing the receiver 160. For these embodiments, the optimization parameters 198 may include, but are not limited to, the provider inputs (which are used by the simulator 194), the internal inputs (which are used by the optimizer 196), and the location of the beam footprint 180 encompassing the receiver 160 (which is used by the optimizer 196).

In at least one embodiment, the simulator 194 may utilize models to imitate the operation of the real-world system to generate the simulated receiver data, which is used to determine an optimized course of action (e.g., what beams to utilize and what data to send, and in what way). In one or more embodiments, broadcast regions and/or receiver regions may be included in the simulation. The regions may be defined with a center point, a size indicator (e.g., such as a diameter), a start time, and a stop time, and/or a specific broadcast or receiver region type. In at least one embodiment, a subscription service type may be mapped and/or used to inform a broadcast region.

In at least one embodiment, the simulator 194 may simulate the environment and application of the receiver to be consistent with the environment/application of paying customer(s) in each region to optimize the expected overall performance based on a weighted cost function. For example, if a more important customer has not seen a message type X in twenty (20) seconds and a customer subscribing to a lower level of service has not seen a message type Y in 30 seconds, then from the simulation, the optimizer 196 may determine to send message type X at a higher priority than sending message type Y and, as such, the optimizer 196 will assign a higher weight to message type X than to message type Y. In at least one embodiment, this weight determination may cause the optimizer 196 to specify the aspects of the signals such that the signals transmitting the X and Y messages are scheduled accordingly.

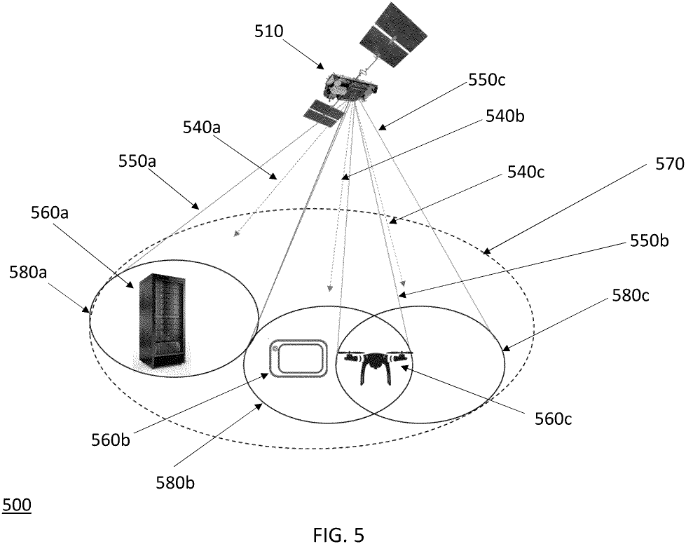

In at least one embodiment, the simulator 194 may consider specific customer use cases for the simulation. An example use case may be where a static ground server, a mobile receiver (e.g., a mobile phone), and an unmanned air vehicle (UAV) are all located within the footprint of the PNT satellite, but are not all located within the same antenna beam footprint (e.g., refer to FIG. 5). In at least one embodiment, the use cases may be represented in the simulator 194 via subscription types, which may specify the types of receivers in the use case, such as static receivers, mobile receivers on the ground, and/or mobile receivers in the air. Alternatively, the use cases may be characterized and captured in other ways for the simulator 194 to leverage, such as through the use of a customer relationship management (CRM) system (e.g., Salesforce), where details of a specific customers deployment may be captured in a database for reference.

In at least one embodiment, the simulator 194 may include in the simulation overlapping antenna beams, and a “canary receiver” (e.g., a simulated service monitoring receiver) may be located within the simulation in a location to model, for example, the worst case boundaries and help to inform the system when a specific set of users in a region of interest may be in need of a broadcast to ensure they do not start operating outside of the desired performance standards. In at least one embodiment, the “canary receiver” may be located in the common overlapping area shared between the overlapping antenna beams.

In one or more embodiments, the provider inputs may include, but are not limited to, at least one user subscription specification, at least one service specification, at least one region of interest, at least one use case, at least one user receiver performance requirement, a receiver environment, and/or at least one broadcast requirement. The receiver environment may be related to environment attenuation and/or receiver mobility associated with the receiver 160. Each of the user subscription specifications may include, but is not limited to, a feature-based LoS, a LoS, and/or a QoS associated with the receiver 160. The feature-based LoS may involve at least one feature that is enabled. This may include a specific receiver that pays to enable a specific feature or validation as part of their service offering. Each of the service specifications may include, but is not limited to, at least one input from an SLA associated with the receiver 160. Each of the user receiver performance requirements may be related to hardware associated with the receiver 160.

In one or more embodiments, each of the broadcast requirements may be based on at least one user application associated with the receiver 160. Each of the user applications may be based on an RF environment and/or receiver mobility associated with the receiver 160.

In at least one embodiment, each of use cases may be based on an RF environment, at least one region, and/or receiver mobility associated with the receiver 160. In some embodiments, each of the use cases may be related to whether the receiver 160 is a static receiver, a pseudo-static receiver, a low dynamic receiver, a highly dynamic receiver, a mobile receiver, an indoor receiver, an outdoor receiver, a land-based receiver, a high-altitude receiver, an air-based receiver, a marine-based receiver, an ocean-based receiver, a connected receiver, an unconnected receiver an unconnected receiver, and/or a combination of these. In some embodiments, the use case is related to the industry in which it is used, such as if the receiver is supporting at least one of the following industries: autonomous operation, automotive, aviation, communications, computer security, financial, delivery, industrial, marine, micromobility, mining, rail, robotics, unmanned systems, precision timing, or telecommunications. In some embodiments, each of the broadcast requirements may be dependent upon at least one use case associated with the receiver 160.

In one or more embodiments, the internal inputs (which are used by the optimizer 196) may include, but are not limited to, costs, business constraints, input parameters, receiver performance associated with the receiver 160, collective user receiver performance, service thresholds, system performance, system constraints, output parameters, available resources, at least one satellite mission, and/or at least one satellite orbit.

FIG. 1C is a diagram of the disclosed PNT satellite and data scheduling system leveraging a simulated receiver network 106, in accordance with at least one embodiment of the present disclosure. In one or more examples, a region controller 102 sets up broadcast information, such as the location of broadcasts and other provider inputs. A payload planner 104 generates a list (e.g., a burst command list) of possible data to be broadcast by satellite beams covering regions with configured broadcasts as a function of time. A simulated receiver network 106 comprises one or more simulated receivers, generally within broadcast regions defined by the region controller 102 that simulate the behavior of a receiver (e.g., the receiver 160) in that region consistent with provider inputs, such as receiver dynamics and attenuation environment. A broadcast optimizer 112 selects (e.g., by utilizing a heuristic intelligent scheduler 114 and/or machine learning 116), from the burst command list, a burst that optimizes the overall system performance for each opportunity to send from a satellite beam, and sends that burst command to the uplink gateway 120 for uplink to the appropriate satellite (e.g., the PNT satellite 110). The broadcast optimizer 112 also sends the burst command to the simulated receiver network 106 so that the simulated receiver network 106 can simulate the bursts that would be received by receivers (e.g., the receiver 160) in the network. The satellite 110 sends the burst on the commanded beam at the commanded time. The user receiver(s) 160 and receivers in a physical receiver network 108 of ground monitoring stations track the bursts. The receivers in the physical receiver network 108 and/or simulated receiver network 106 provide feedback to the broadcast optimizer 112 about what bursts were received and/or shortfall information (e.g., burst data needed, but not recently enough received). In other embodiments, the broadcast is a continuous signal instead of bursts; in those embodiments, the data may be sent in pages instead of bursts.

In one embodiment, the simulated receiver network 106 leverages ten types of information that need to be sent. The data may be sent in an atomic block (e.g., a subframe, packet, etc.). The types of day may include, but may not be limited to, the following data types: 1.) Eccentricity, 2.) Semi-major axis, 3.) Inclination, 4.) Longitude of ascending node, 5.) Argument of perigee, 6.) True anomaly, 7.) Satellite clock bias, 8.) Satellite clock frequency error, 9.) Validation Data, and 10.) Earth Orientation and UTC offset data (not satellite specific). In at least one embodiment, a broadcast is optimized using inputs from one or more customers that require each data type at a specific frequency, which may include not requiring one or more data types at all. As an example, a specific customer’s application does not require data type 10 because this customer’s receivers (e.g., the receiver 160) have periodic connection to the internet, and do not need data that changes as rarely/slowly as UTC offset and Earth orientation data. Additionally, in this example, the orbital elements may be expressed as a mean element set, such that they change slowly with some elements changing faster/more unpredictably than others (e.g., due to drag). For this reason, this customer’s receivers (e.g., the receiver 160), due to their intermittent connectivity to the internet, can get updates to slower changing parameters from the broadcast less frequently than others, and achieve their desired time to first fix. In this example, they may need satellite clock bias data every sixty (60) seconds, satellite frequency error every ninety (90) seconds, true anomaly every 120 seconds, other orbit parameters every 180 seconds, and validation data every forty-five (45) seconds. For example, a per data type shortfall metric may be defined for data type i for satellite j for broadcast k as:
S_i_j_k = (current_time - last_data_i_j_k)/required_period_i_k,
where: last_data_i_j_k is the last time data type i was received (by a simulated receiver or a physical broadcast monitoring receiver) for satellite j in broadcast region k, and required_period_i_k is the required update period for data type i (e.g., 120 seconds for data type 6). The time since each message type would be seen for a receiver at each broadcast region would be simulated based on the location of the service region and parameters, such as the expected power flux density for a receiver for broadcast k to be received (e.g., if broadcast 1 is known to be servicing indoor receivers, the last time data was received would only be updated in the simulation when the simulated power flux density at that location was high enough to be received indoors). In this example, if the receivers have not seen data type 6 in 60 seconds for satellite 1 in broadcast region 1:
S_6_1_1 = 60/120 = = 0.5. If they have not seen data type 3 in 80 seconds for satellite 1:
S_3_1_1 = 80/180 = 0.444. So although they have gone longer without seeing data type 3 than data type 6, data type 6 has a bigger shortfall metric. If it is additionally assumed, for example, that there is another customer broadcast with a nearby broadcast region that has different requirements such that: S_6_1_2 = 40/50 = 0.8 S_3_1_2 = 90/180 = 0.5, the highest shortfall metric is S_6_1_2 = 0.8. So, if one of the data type options that will be received by a receiver in broadcast region 2 is message type 6 for satellite 1, that data type might be selected for broadcast. It should be noted that algorithm could be extended to support a level of service by multiplying the shortfall metric by a service level by:
weighting value.S_i_j_k = (current_time - last_data_i_j_k)/required_period_j_k*W_k, where W_k is a service level weighting value which increases for higher service levels. For example, below is pseudocode that may be employed by the optimizer to select the optimum burst type from the burst command list:

for ii in group of possible burst commands for a specific combination of
frame/sv/beam {
for jj in burst shortfall list {
if frame/sv/beam would be tracked for the region corresponding to shortfall jj {
if (shortfall jj is bigger than biggest_shortfall) {
biggest_shortfall = shortfall jj;
optimal burst command = possible burst command ii;
}
}
}
}

Then we select optimal_burst_commands for that frame/sv/beam.

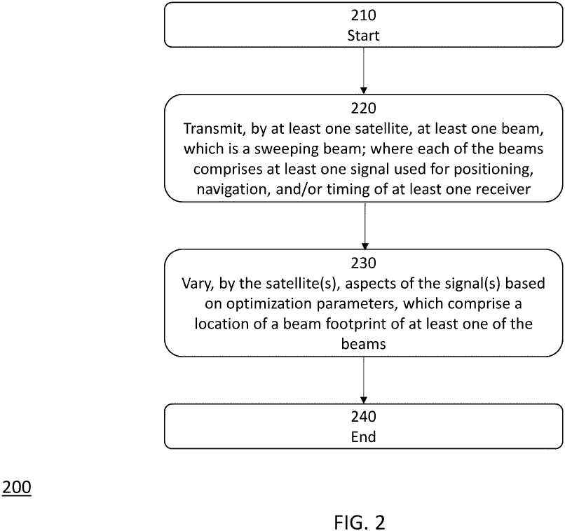

FIG. 2 is a flowchart illustrating a disclosed method 200 of operation of the disclosed PNT satellite beam and data scheduling system, in accordance with at least one embodiment of the present disclosure. After the start 210 of the method 200, at step 220, at least one satellite (e.g., PNT satellite 110 of FIG. 1A) transmits at least one beam (e.g., beam 150 of FIG. 1A), which is a sweeping beam, where each of the beams comprises at least one signal (e.g., signal 140 of FIG. 1A) used for positioning, navigation, and/or timing of at least one receiver (e.g., receiver 160 of FIG. 1A). At step 230, at least one satellite varies aspects of at least one signal based on optimization parameters, which comprise at location of a beam footprint (e.g., beam footprint 180 of FIG. 1A) of at least one of the beams. Then, the method 200 ends 240.

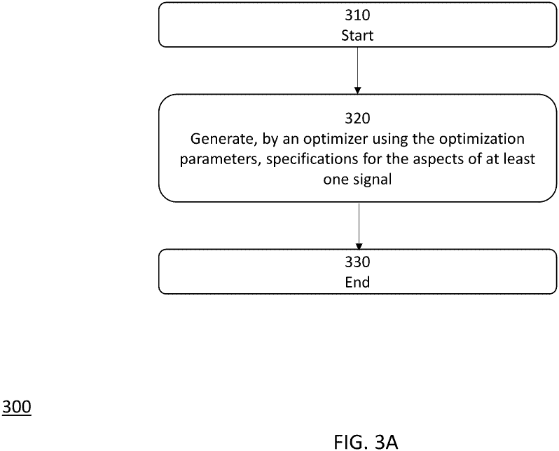

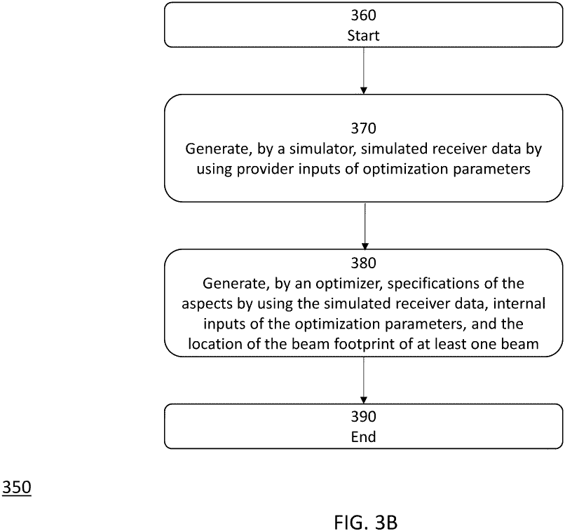

FIG. 3A is a flowchart illustrating a disclosed method 300 for determining specifications for aspects of signals transmitted from PNT satellites of the disclosed PNT satellite beam and data scheduling system, in accordance with at least one embodiment of the present disclosure. After the start 310 of the method 300, at step 320, an optimizer (e.g., optimizer 196 of FIG. 1B) which may be run on an optimizer processor (e.g., optimizer processor 195 of FIG. 1B), by using optimization parameters, generates specifications for the aspects of at least one signal (e.g., signal 140 of FIG. 1A). Then, the method 300 ends 330.

FIG. 3B is a flowchart illustrating a disclosed method 350, utilizing simulated receiver data, for determining specifications for aspects of signals transmitted from PNT satellites of the disclosed PNT satellite beam and data scheduling system, in accordance with at least one embodiment of the present disclosure. After the start 360 of the method 350, at step 370, a simulator (e.g., simulator 194 of FIG. 1B), which may be run on a simulator processor (e.g., simulator processor 193 of FIG. 1B), generates simulated receiver data by using provider inputs of optimization parameters. Then, at step 380, an optimizer (e.g., optimizer 196 of FIG. 1B), which may be run on in optimizer processor (e.g., optimizer processor 195 of FIG. 1B), generates specifications of the aspects of at least one signal (e.g., signal 140 of FIG. 1A), by using the simulated receiver data, internal inputs of the optimization parameters, and the location of the beam footprint (e.g., beam footprint 180 of FIG. 1A) of at least one beam (e.g., beam 150 of FIG. 1A). Then, the method 350 ends 390.

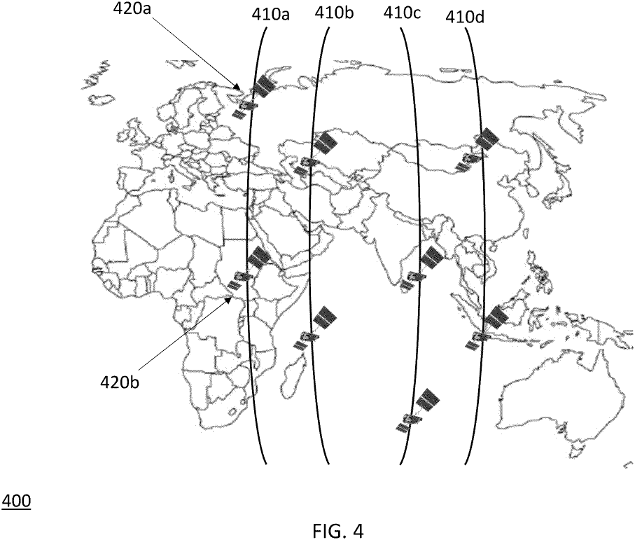

FIG. 4 is a diagram showing exemplary orbital paths 410a, 410b, 410c, 410d of multiple disclosed PNT satellites 420a, 420b that may be employed for the disclosed PNT satellite beam and data scheduling system 400, in accordance with at least one embodiment of the present disclosure. In this figure, the system 400 comprises a plurality of PNT satellites within a LEO satellite constellation. The PNT satellites are shown to be orbiting on specific orbital paths (e.g., orbits) 410a, 410b, 410c, 410d. For example, PNT satellites 420a, 420b are orbiting on orbital path 410a. It should be noted that each orbital path 410a, 410b, 410c, 410d may have the PNT satellites orbiting in a South to North direction or in North to South direction. In at least one embodiment, a receiver may be in a region that is covered by beams from satellites that are moving in different directions and, thus, receiving data from satellites moving South to North as well as from satellites moving North to South. Such orbital knowledge may be used to optimize what is scheduled over specific regions in which receivers are presumed to be in.

In one or more embodiments, the disclosed system 400 may comprise more or less PNT satellites than as shown in FIG. 4. In addition, the PNT satellites of the disclosed system 400 may orbit on more or less orbital paths 410a, 410b, 410c, 410d than as shown in FIG. 4. In at least one embodiment, the disclosed system 400 may comprise PNT satellites in one or more orbit altitudes (e.g., LEO, MEO, and/or GEO) and from one or more satellite constellations.

FIG. 5 is a diagram showing multiple different receivers 560a, 560b, 560c located within antenna beams 550a, 550b, 550c transmitted from a disclosed PNT satellite 510 of the disclosed PNT satellite beam and data scheduling system 500, where one of the receivers 560c is located within two of the beams 550b, 550c, in accordance with at least one embodiment of the present disclosure. In this figure, receiver 560a is a ground server, receiver 560b is a satellite phone, and receiver 560c is in a UAV.

During operation of the disclosed system 400, the PNT satellite 510 transmits antenna beams 550a, 550b, 550c comprising signals 540a, 540b, 540c towards Earth. The signals 540a, 540b, 540c are used for positioning, navigation, or timing for the receivers 560a, 560b, 560c. The antenna beams 550a, 550b, 550c (which are sweeping beams) radiate on Earth and form beam footprints 580a, 580b, 580c on the ground. Also, during operation, the satellite may vary aspects of the signals 540a, 540b, 540c transmitted towards Earth.

In this figure, the receivers 560a, 560b, 560c are all located within a footprint 570 of the PNT satellite 510, but are not all located within the same antenna beam footprint 580a, 580b, 580c of the antenna beams 550a, 550b, 550c. In particular, receiver 560a is located within beam footprint 580a, receiver 560b is located within beam footprint 580b, and receiver 560c is located within beam footprints 580b, 580c.

In one or more embodiments, as previously mentioned above, the simulator 194 (refer to FIG. 1B) may consider specific use scenarios for the simulation, which is used to determine specifications for the aspects of the signals 540a, 540b, 540c that are varied. For example, one scenario may be, as shown in FIG. 5, where a static ground server (e.g., receiver 560a) can only receive coverage from a first antenna beam (e.g., beam 550a), a mobile receiver (e.g., receiver 560b) can only receive coverage from a shared second antenna beam (e.g., beam 550b) with a UAV (e.g., receiver 560c), and the UAV can also receive coverage from a third antenna beam (e.g., beam 550c). In at least one embodiment, the optimizer 196 (e.g., refer to FIG. 1B) may weigh the simulated receiver data (e.g., which may include the simulation comprising simulated receiver performance of the receivers 560a, 560b, 560c and/or other simulated receivers) along with optimization parameters (e.g., input parameters, costs, service thresholds, system performance, and/or system constraints) to determine that the third antenna beam (e.g., beam 550c) may be turned on at a given time to support the mobile receiver (e.g., receiver 560b) and the UAV (e.g., receiver 560c), but that the performance of the remaining receiver (e.g., receiver 560a) is not expected to be within the required performance specifications without a broadcast of the first antenna beam (e.g., beam 550a) to Earth at that time.

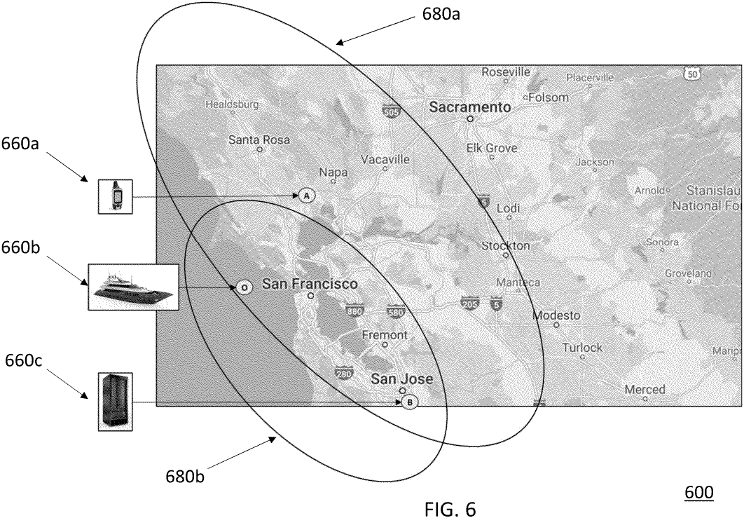

FIG. 6 is a diagram showing multiple different receivers 660a, 660b, 660c located within antenna beams 680a, 680b transmitted from at least one disclosed PNT satellite (e.g., refer to PNT satellite 110 of FIG. 1A) of the disclosed PNT satellite beam and data scheduling system 600, where two of the receivers 660b, 660c are located within two of the beams 680a, 680b, in accordance with at least one embodiment of the present disclosure. In this figure, receiver 660a is a satellite phone, receiver 660b is on a ship, and receiver 660c is a ground server.

In this figure, the three receivers 660a, 660b, 660c are located within the two beams 680a, 680b, which are not necessarily both transmitted from the same PNT satellite. Two of the receivers (i.e. receivers 660b, 660c) are located within one beam 680b, where receiver 660c is located on land and operating indoors and receiver 660b is located on a ship in the ocean. The remaining receiver (i.e. receiver 660a) is located in a different beam 680a, and is operating on land using a mobile outdoor application.

When two or more antenna beams (transmitted from one or more PNT satellites) have overlapping footprints, broadcasts of those beams can be adjusted to deconflict or save power, or even to provide enhanced power levels for specific applications. For example, static applications may require lower burst rates then dynamic applications. In regions with a high percentage of static users, broadcasts for antenna beams with overlapping coverage can be alternated to save power.

In the example shown in FIG. 6, receiver 660b, which may be a luxury yacht, may have paid for a higher LoS. And, receiver 660c, which may be an indoor static server, may require high power signals to allow for signal penetration into the building. As such, the disclosed system 600 may use this knowledge regarding the locations and transmission requirements of the receivers 660b, 660c in the shared antenna beams 680b, 680c to make informed decisions regarding the broadcasts for the antenna beams 680b, 680c.

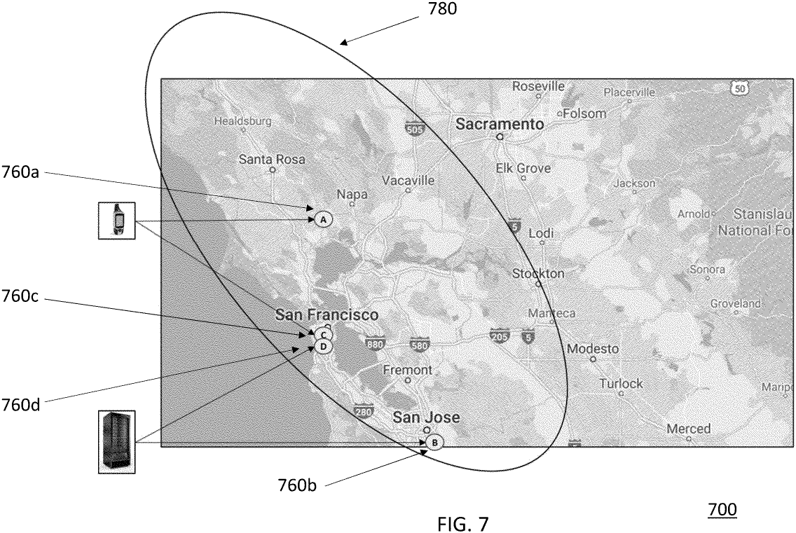

FIG. 7 is a diagram showing multiple different receivers 760a, 760b, 760c, 760d located within an antenna beam 780 transmitted from a disclosed PNT satellite (e.g., refer to PNT satellite 110 of FIG. 1A) of the disclosed PNT satellite beam and data scheduling system 700, in accordance with at least one embodiment of the present disclosure. In this figure, receivers 760a, 760c are satellite phones, and receivers 760b, 760d are ground servers.

In at least one embodiment, receivers 760c, 760d are considered to be located at an indistinguishable distance from one another (e.g., with both receivers located on the ground, or with one receiver on the ground and the other receiver in the air). However, receivers 760c, 760d may have different broadcast requirements. The disclosed intelligent data scheduler 192 may optimize the broadcasts of the signal(s) within the antenna beam 780 to interleave and/or multiplex (e.g., by multiplexing the data for both receivers 760c, 760d utilizing a multiplexing scheme, such as a time multiplexing scheme or a frequency multiplexing scheme), or otherwise alternate, the data sent in the signal(s) via the broadcast, while considering the needs of the various receivers (e.g., receivers 760c, 760d and/or other nearby receivers) within the region.

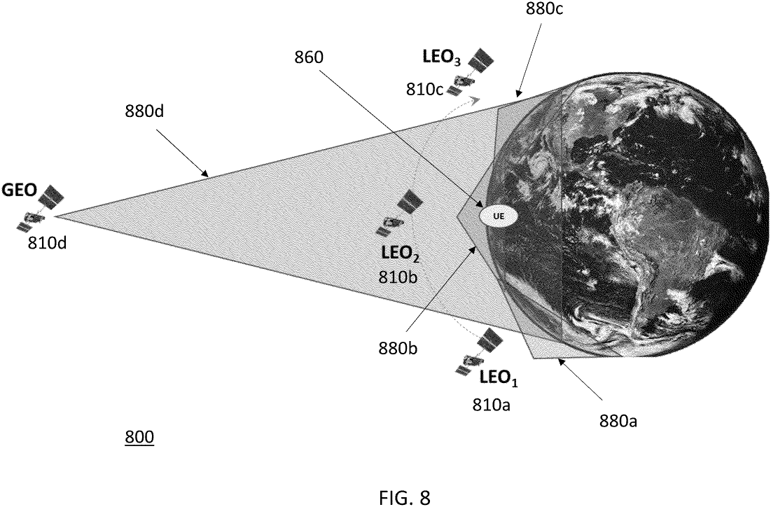

FIG. 8 is a diagram showing the disclosed PNT satellite beam and data scheduling system 800 employing multiple disclosed PNT satellites 810a, 810b, 810c, 810d from multiple exemplary satellite constellations (i.e. a LEO satellite constellation and a GEO satellite constellation), in accordance with at least one embodiment of the present disclosure. As previously mentioned above, the disclosed system 800 may employ satellites from one or more satellite constellations at one or more orbits with one or more orbital inclinations. For example, the disclosed system 800 may leverage satellites from LEO satellite constellations (e.g., Iridium, SpaceX Starlink, and OneWeb, as well as small or nanosat constellations, such as LeoSat, TeleSat, Hongyan, and SpaceBEEs), GNSS satellites (e.g., GPS, Galileo, GLONASS, and BeiDou), and/or MEO satellite constellations (e.g., GPS and O3b).

In at least one embodiment, satellites in multiple different orbit configurations and/or satellite constellations may be employed by the disclosed system 800, such as a GEO satellite 810d being cooperatively used with LEO satellites 810a, 810b, 810c, as is shown in FIG. 8. In particular, the system 800 of FIG. 8 is shown to include LEO satellites 810a, 810b, 810c radiating antenna beams 880a, 880b, 880c, and a GEO satellite 810d radiating antenna beam 880d.

In one or more embodiments, a satellite constellation (e.g., a LEO satellite constellation) may be employed and another set of satellites from another orbit and/or constellation (e.g., a GEO satellite constellation) may be additionally leveraged as determined by the system 800 to help improve receiver performance when a specific subscription and/or specific receiver performance is desired. For example, in FIG. 8, receiver 860 (e.g., user equipment (UE)) is shown to receive antenna coverage from both the antenna beam 880b radiated from LEO satellite 810b and from the antenna beam 880d radiated from GEO satellite 810d.

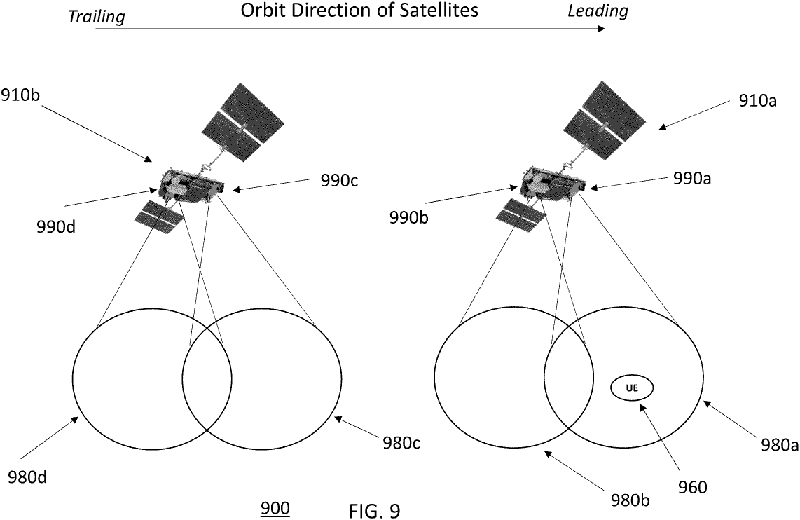

FIG. 9 is a diagram showing two exemplary disclosed PNT satellites 910a, 910b, each radiating a leading antenna beam 980a, 980c and a trailing antenna beam 980b, 980d, that may be employed for the disclosed PNT satellite beam and data scheduling system 900, in accordance with at least one embodiment of the present disclosure. In particular, in this figure, the PNT satellites 910a, 910b are orbiting on the same orbital path in a direction from left to right, such that PNT satellite 910a is leading and PNT satellite 910b is trailing on the same orbital path behind PNT satellite 910a.

Antennas 990a, 990b, 990c, 990d on the PNT satellites 910a, 910b radiate antenna beams such that each PNT satellite 910a, 910b radiates two antenna beams. The two antenna beams of each of the PNT satellites 910a, 910b include a leading antenna beam 980a, 980c (which may be referred to as a “headlight”) and a trailing antenna beam 980b, 980d (which may be referred to as a “taillight”). Specifically, in this figure, a receiver 960 (e.g., a UE) is located within the leading beam 980a of PNT satellite 910a.

In one or more embodiments, the optimizer 196 (e.g., refer to FIG. 1B) may determine specifications for the aspects of the signals transmitted within the beams 980a, 980b, 980c, 980d such that the aspects (e.g., such as data content) of the signals for the leading beams 980a, 980c are varied differently than (or, alternatively, similarly to) the aspects of the trailing beams 980b, 980d. For example, the signals of the leading beams 980a, 980c may comprise orbital information data regarding the PNT satellite radiating the beams being actively received by the receiver 960 and may comprise data that is often transmitted on a fast data rate (e.g., referred to as “fast data”). Alternatively, when a PNT satellite also transmits a middle beam (which is located between the leading beam and the trailing beam), the signals in the middle beam, instead of the leading beam 980a, 980c, may comprise the “fast data.” The signals of the trailing beams 980b, 980d may comprise orbital data for an upcoming PNT satellite (e.g., PNT satellite 910b) for the receiver 960 as well as may comprise data that is often transmitted on a slow data rate (e.g., referred to as “slow data”), such as orbital information regarding other satellites in the system 900. For example, in FIG. 9, since PNT satellite 910b is trailing behind PNT satellite 910a on the same orbital path and since the receiver 960 is located within a leading beam 980a of the PNT satellite 910a, the PNT satellite 910b is an upcoming PNT satellite for the receiver 960. It should be noted that the leading antenna beam and trailing antenna beam do not have to be radiated from the same satellite. In at least one embodiment, these may be employed by different satellites in different satellite constellations that may have different orbital configurations. In at least one embodiment, the orbital configuration may help lend itself to different types of data transmissions (e.g., “fast data” and “slow data”).

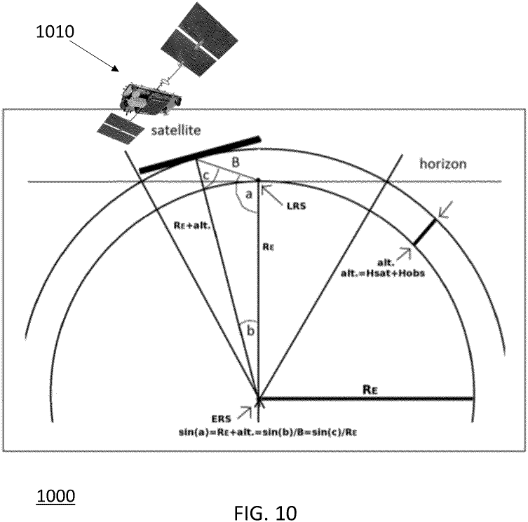

FIG. 10 is a diagram showing geometry 1000 for a disclosed PNT satellite 1010 of the disclosed PNT satellite beam and data scheduling system, in accordance with at least one embodiment of the present disclosure. In particular, this figure shows the viewing geometry 1000 of the PNT satellite 1010 relative to Earth and the horizon, where R_{E} is the radius of the Earth and alt is the altitude of the PNT satellite 1010. Angle C is the viewing angle from the PNT satellite 1010 to the location of the receiver at LRS. Angle B is the Earth separation angle between the PNT satellite 1010 and the location of the receiver at LRS. The angles A, B, and C in the geometry 1000 are related through the law of sines.

The various operations of methods described above may be performed by any suitable means capable of performing the corresponding functions. The means may include various hardware and/or software component(s) and/or module(s), including, but not limited to a circuit, an application-specific integrated circuit (ASIC), or processor.

By way of aspect, an element, or any portion of an element, or any combination of elements described herein may be implemented as a “processing system” that includes one or more processors. Aspects of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout the disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more aspect embodiments, the functions or circuitry blocks described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of aspect, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer. In some aspects, components described with circuitry may be implemented by hardware, software, or any combination thereof.

The phrase “coupled to” and the term “coupled” refers to any component that is physically connected to another component either directly or indirectly, and/or any component that is in communication with another component (e.g., connected to the other component over a wired or wireless connection, and/or other suitable communication interface) either directly or indirectly.

Generally, where there are operations illustrated in figures, those operations may have corresponding counterpart means-plus-function components with similar numbering.

As used herein, the term “determining” encompasses a wide variety of actions. For aspect, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an aspect, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for determining at least one of location or time offset of at least one receiver, the method comprising:
transmitting, by at least one satellite, at least one beam, which is a sweeping beam,
wherein each of the at least one beam comprises at least one signal used for at least one of positioning, navigation, or timing; and
varying, by the at least one satellite, aspects of the at least one signal based on optimization parameters, wherein the optimization parameters comprise a location of a beam footprint of at least one of the at least one beam,
wherein the at least one receiver receives at least one of the at least one signal, and
wherein at least one of the location or the time offset of at least one of the at least one receiver is determined by using at least one of the at least one signal.

2. The method of claim 1, wherein the method further comprises generating, by an optimizer using the optimization parameters, specifications for the aspects.

3. The method of claim 1, wherein the optimization parameters further comprise provider inputs and internal inputs, and
wherein the method further comprises:
generating, by a simulator using the provider inputs, simulated receiver data; and
generating, by an optimizer using the simulated receiver data, the internal inputs, and the location of the beam footprint of at least one of the at least one beam, specifications of the aspects.

4. The method of claim 3, wherein the simulated receiver data is associated with at least one simulated service monitoring receiver.

5. The method of claim 3, wherein the provider inputs comprise at least one of at least one user subscription specification, at least one service specification, at least one region of interest, at least one use case, at least one user receiver performance requirement, at least one receiver environment, or at least one broadcast requirement.

6. The method of claim 5, wherein each of the at least one receiver environment comprises at least one of environment attenuation or receiver mobility associated with at least one of the at least one receiver.

7. The method of claim 5, wherein each of the at least one user subscription specification comprises at least one of a feature-based level of service (LoS), a LoS, or a quality of service (QoS) associated with at least one of the at least one receiver.

8. The method of claim 7, wherein the feature-based LoS comprises at least one feature enabled.

9. The method of claim 5, wherein each of the at least one service specification comprises at least one input from a service level agreement (SLA) associated with at least one of the at least one receiver.

10. The method of claim 5, wherein each of the at least one user receiver performance requirement is related to hardware associated with at least one of the at least one receiver.

11. The method of claim 5, wherein each of the at least one broadcast requirement is based on at least one user application associated with at least one of the at least one receiver.

12. The method of claim 11, wherein each of the at least one user application is based on at least one of a radio frequency (RF) environment or receiver mobility associated with at least one of the at least one receiver.

13. The method of claim 5, wherein each of the at least one use case is based on at least one of a RF environment, at least one region, or receiver mobility associated with at least one of the at least one receiver.

14. The method of claim 5, wherein each of the at least one use case is related to whether the at least one receiver is at least one of a static receiver, a pseudo-static receiver, a low dynamic receiver, a highly dynamic receiver, a mobile receiver, an indoor receiver, an outdoor receiver, a land-based receiver, a high-altitude receiver, an air-based receiver, a marine-based receiver, an ocean-based receiver, a connected receiver, or an unconnected receiver.

15. The method of claim 5, wherein each of the at least one broadcast requirement is dependent upon the at least one use case associated with at least one of the at least one receiver.

16. The method of claim 3, wherein the internal inputs comprise at least one of costs, business constraints, input parameters, receiver performance associated with at least one of the at least one receiver, collective user receiver performance, service thresholds, system performance, system constraints, output parameters, available resources, at least one satellite mission, or at least one satellite orbit.

17. The method of claim 1, wherein the optimization parameters further comprise at least one of a level of service (LoS) associated with at least one of the at least one receiver, a quality of service (QoS) associated with at least one of the at least one receiver, at least one region of service associated with at least one receiver of the at least one receiver, a broadcast type associated with at least one receiver of the at least one receiver, costs, receiver performance associated with at least one receiver of the at least one receiver, business constraints, input parameters, collective user receiver performance, service thresholds, system performance, system constraints, output parameters, service monitoring receiver data, or available resources.

18. The method of claim 1, wherein the aspects of the at least one signal comprise at least one of beam scheduling, data content, signal power, data coding gain, data rate, frequency, coding scheme, error correction, or modulation.

19. The method of claim 18, wherein when at least one of the at least one receiver is located within at least two of the at least one beam, which are overlapping, the beam scheduling comprises scheduling each of the at least two of the at least one beam to alternately broadcast to the at least one of the at least one receiver.

20. The method of claim 18, wherein the signal power is varied based on specified power levels of at least one broadcast requirement.

21. The method of claim 18, wherein the signal power is varied based on predicted signal attenuation due to at least one of indoor transmission, any obstructed views, receiver antenna gain, weather, interference, or jamming.

22. The method of claim 18, wherein the data content comprises at least one of self-satellite information associated with at least one satellite of the at least one satellite, validation information associated with at least one satellite of the at least one satellite, authentication information associated with at least one satellite of the at least one satellite, authentication information associated with at least one receiver of the at least one receiver, or other-satellite information.

23. The method of claim 22, wherein the self-satellite information comprises at least one of an identifier, almanac, ephemerides, health data, or timing information corresponding to the at least one satellite associated with the self-satellite information.

24. The method of claim 22, wherein the authentication information comprises authentication data used to authenticate the at least one receiver associated with the authentication information, when the at least one receiver is determined to be located within an expected location corresponding to the at least one receiver, by comparing the authentication data to a known valid data set, and authenticating the at least one receiver when a difference between the authentication data and the known valid data is below a predetermined authentication threshold.

25. The method of claim 22, wherein the validation information is used to validate authenticity of a source, which is at least one of the at least one satellite, of each of at least one of the at least one signal.

26. The method of claim 22, wherein the validation information comprises at least one digital signature corresponding to at least one of the at least one satellite.

27. The method of claim 1, wherein when there is more than one of the at least one beam transmitted, the aspects of the at least one signal of at least some of the beams are varied one of similarly or differently.

28. The method of claim 1, wherein the at least one satellite is a low earth orbit (LEO) satellite, a medium earth orbit (MEO) satellite, or a geosynchronous earth orbit (GEO) satellite.

29. The method of claim 28, wherein the GEO satellite is a geostationary satellite.

30. The method of claim 1, wherein when there is more than one of the at least one satellite, the satellites are LEO satellites, MEO satellites, GEO satellites, or a combination thereof.

31. The method of claim 1, wherein the at least one satellite is within a satellite constellation.

32. The method of claim 1, wherein when there is more than one of the at least one satellite, the satellites are within at least one satellite constellation.

33. The method of claim 1, wherein when there are at least two receivers, of the at least one receiver, with different service requirements that are all located at a location that is illuminated by the beam footprint of the at least one beam from at least two of the at least one satellite, the at least one signal within each of the at least one beam from the at least two of the at least one satellite comprises multiplexed data for all of the at least two receivers.

34. The method of claim 33, wherein the multiplexed data is multiplexed by utilizing at least one of a time multiplexing scheme or a frequency multiplexing scheme.

35. The method of claim 1, wherein the sweeping of each of the at least one beam is achieved by at least one of the at least one satellite associated with each of the at least one beam moving across a surface of Earth or at least one antenna of the at least one satellite associated with each of the at least one beam scanning the at least one beam.

36. The method of claim 35, wherein each of the at least one beam is scanned by at least one of gimballing the at least one antenna or changing a phase of the at least one beam.

37. The method of claim 35, wherein the at least one antenna comprises at least one of a reflector antenna, a patch antenna, a helix antenna, a cup-dipole antenna, a dipole antenna, a monopole antenna, a direct radiating array antenna, or a phased array antenna.

38. The method of claim 1, wherein each of the beam footprint of the at least one beam is smaller in size than each satellite footprint of the at least one satellite on Earth.

39. The method of claim 1, wherein when there is more than one of the at least one beam transmitted, one of the beams is a leading beam that comprises at least a portion of a first type of data, and another one of the beams is a trailing beam that comprises at least a portion of a second type of data.

40. The method of claim 39, at least a portion of the aspects of the at least one signal in the leading beam are varied differently than at least a portion of the aspects of the at least one signal in the trailing beam.

41. A system for determining at least one of location or time offset of at least one receiver, the system comprising:
at least one satellite configured to transmit at least one beam, which is a sweeping beam,
wherein each of the at least one beam comprises at least one signal used for at least one of positioning, navigation, or timing,
the at least one satellite further configured to vary aspects of the at least one signal based on optimization parameters, wherein the optimization parameters comprise a location of a beam footprint of at least one of the at least one beam,
wherein the at least one receiver receives at least one of the at least one signal, and
wherein at least one of the location or the time offset of at least one of the at least one receiver is determined by at least one PNT processor using at least one of the at least one signal.

42. The system of claim 41, wherein the at least one PNT processor is located in at least one of at least one of the at least one receiver, in at least one server, on at least one of the at least one satellite, or a combination thereof.

43. The system of claim 41, wherein the system further comprises at least one optimizer processor configured to generate, by running an optimizer using the optimization parameters, specifications for the aspects.

44. The system of claim 43, wherein the optimizer performs at least one of a weighted parameter analysis or a cost function analysis.

45. The system of claim 43, wherein the optimizer comprises an intelligent broadcast scheduler configured to generate at least one broadcast schedule.

46. The system of claim 43, wherein the optimizer comprises a region controller configured to specify at least one region to illuminate with at least one of the at least one beam.

47. The system of claim 41, wherein the optimization parameters further comprise provider inputs and internal inputs, and
wherein the system further comprises:
at least one simulator processor configured to generate, by running a simulator using the provider inputs, simulated receiver data; and
at least one optimizer processor configured to generate, by running an optimizer using the simulated receiver data, the internal inputs, and the location of the beam footprint of at least one of the at least one beam, specifications of the aspects.

48. The system of claim 47, wherein the simulator employs machine learning.
